(19) United States
(12) Patent Application Publication
(10) Pub. No.: US 2005/0194373 A1
(43) Pub. Date: Sep. 8, 2005

(54) Cooking surface with a barrier

(75) Inventor: Gerd Wilsdorf, Olching (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 11/068,643

(22) Filed: Feb. 28, 2005

(30) Foreign Application Priority Data
Aug. 30, 2002 (DE) 10240147.0
Aug. 20, 2003 (WO) PCT/EP03/09240

(51) Int. Cl. H05B 3/68

(52) U.S. Cl. 219/443.1

(57) ABSTRACT

A cooking surface made of glass ceramic or comparable material having a cooking area with cooking plates and a control panel with operation and control elements formed on the surface. The cooking area and the control panel are separated from one another by a barrier between and separating the two. The barrier extends across the entire cooking surface and preferably all three, the barrier, the cooking area and the control panel are made from the same material, preferably in one piece.

The invention relates to a cooking surface made of glass ceramic or another comparable material, comprising a cooking area having heatable hot plates and a control panel having edge-side operating and/or display elements, wherein cooking area and control panel are delimited from one another. A material which is comparable to glass ceramic, especially with regard to hardness, melting point and electrical insulating properties, should be regarded as other comparable material.

The cooking surface of a glass ceramic cooking appliance in the sense specified initially is shown in DE-PS 3144987. In this case, the cooking surface consists of a glass-ceramic cooking area with radiative heating elements located thereunder and a control panel possibly made of a transparent material. The cooking area and control panel having operating and display elements for the radiative heating elements are mounted in a frame-like support from which a supporting spar runs transverse to the lateral boundaries between the cooking area and control panel, whereby these areas are completely separated from one another by a distance. This supporting spar connected to the other peripheral supporting spars extends as far as the plane of the cooking area and presents a visually well perceivable marking for the boundary of the cooking area.

In another known cooking surface (EP 0930806A1) a plurality of hot plates and also operating and display elements are integrated in an oval glass ceramic plate. In this case, the edge-side operating and display elements are arranged behind a bead-like elevation which passes through the glass ceramic plate only partially in the area of said elements, which elevation is formed from the glass ceramic material and presents a perceptible marking for the area of the display and operating elements. No complete boundary is hereby provided between cooking area and control panel, for example, to protect the operating area from overflowing boiling liquid from the hot plates.

It is the object of the present invention to configure the cooking surface such that in addition to a formal, visually clearly identifiable division of cooking area and control area, there is a complete, perceptible and liquid-repelling barrier between these areas.

This object is solved with the generic cooking surface in that the cooking area and control panel are formed from the same material and that between the cooking area and control panel there is a barrier which extends over the total length of the panel, which is formed from the aforesaid material and interrupts the surfaces of the cooking area and control panel. Advantageously in this case, the cooking area, control panel and barrier are formed in one piece.

According to the aforesaid formulation of the problem, a cooking surface is thus obtained whose functional areas (cooking area, control panel) are visually and physically separated from one another. Compared with known designs with functional areas also delimited from one another, it is especially advantageous that for this boundary no particular transverse supporting spar is required, for example as part of a frame surrounding the cooking surface. Rather, according to the invention a standard, closed and therefore gap- and join-free overall surface is obtained which is characterised in that it is very easy to clean.

From the manufacturing technology point of view, numerous possibilities for shaping the barrier are opened up by the design of the cooking surface according to the invention. The barrier is preferably constructed as an elongated, bead-like elevation or as an elongated roof-shaped elevation. In this case, it is advantageous if the cooking area and control panel are located in a common plane.

According to another embodiment of the cooking surface according to the invention, the control panel is arranged at an inclination to the horizontal cooking area. In this case, the cooking area can be delimited by a step-like barrier to which the control panel is obliquely adjacent and thus is facing the operator in an advantageous fashion.

According to a further embodiment of the invention, the cooking surface which is rectangular in outline is provided at least at two opposing surface edges with boundary strips adjacent to the ends of the elongated barrier. In this case, it is undamaging with respect to the physical boundary of cooking surface and control panel if, for reasons of production technology, a small gap remains between said ends of the elongated barrier and the lateral boundary strips.

The invention is explained subsequently with reference to two exemplary embodiments shown in the drawings.

In the figures:

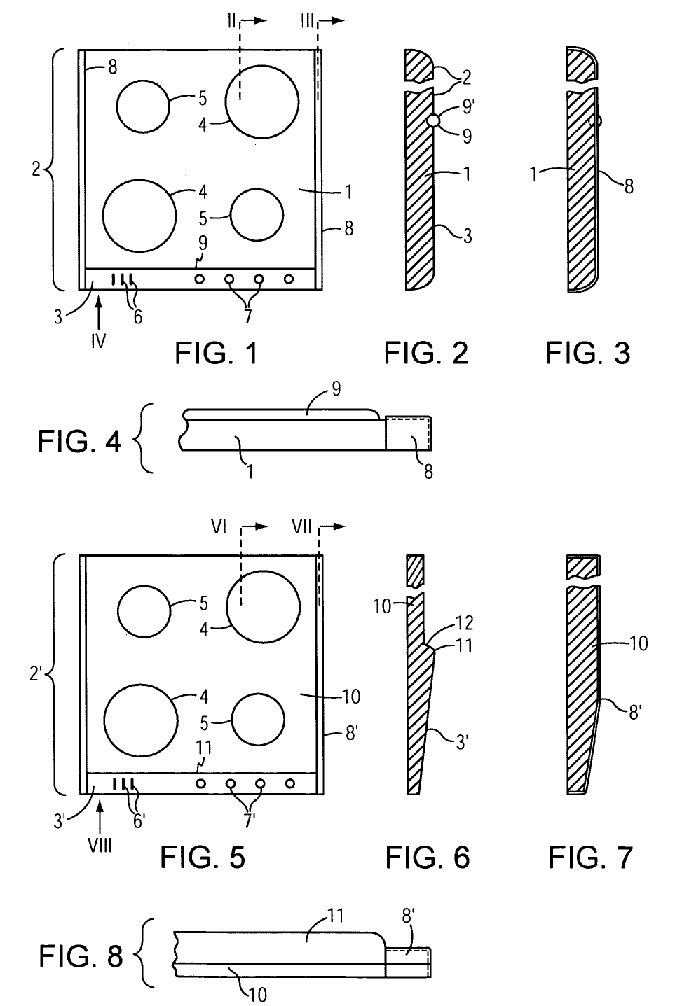

FIG. 1 is a plan view of a first exemplary embodiment of the cooking surface according to the invention,

FIG. 2 is a sectional view of the cooking surface along the line of intersection II in FIG. 1, shown enlarged and separated,

FIG. 3 is a sectional view of the cooking surface, also enlarged, along the line of intersection III in FIG. 1,

FIG. 4 is a front view of the cooking surface in the direction of the arrow IV in FIG. 1, which view is also shown enlarged,

FIGS. 5 to 8 show diagrammatic views of a second embodiment of the cooking surface according to the invention corresponding to those of FIGS. 1 to 4.

In both exemplary embodiments according to FIGS. 1 to 4 and 5 to 8, a plate-like cooking surface made of a glass-ceramic material is shown whose hot plates and operating and display elements are indicated by dashed markings for which however, a substructure usually provided which includes the relevant radiant heating elements and switching and display elements such as LED display elements and mechanical switches or contact switches, is not shown.

In the exemplary embodiment according to FIGS. 1 to 4, the rectangular cooking surface 1 is divided into a cooking area 2 and a control panel 3. The cooking area 2 has four circular hot plates 4, 5 of different diameter whereas the control panel 3 has indicated display elements 6 and switch elements 7. The cooking area 2 and control panel 3 are located in a common plane and are integral components of the cooking surface 1, i.e., they consist of the same glass ceramic material which for example can be constructed as transparent in the area of the display and operating elements 6, 7. On the two opposing surface edges the glass ceramic plate is provided with boundary strips 8, consisting of plastic or stainless steel for example, which enclose the edge regions, as shown in FIGS. 1, 3 and 4.

FIGS. 1 and 2 show that the cooking area 2 and control panel 3 are separated from one another by a barrier 9 in the form of a bead-shaped, semicircular and elongated elevation, which is formed integrally of the glass ceramic material, which passes through the cooking surface 1 transversely and over its total width. This barrier 9 clearly projects above the horizontal planes of the cooking area 2 and control panel 3 and represents a clearly identifiable, perceptible and liquid-tight and in this case, homogeneous boundary of the total cooking area 2 from the total control panel 3. Printing 9′ is applied in the apex section of the barrier 9 which gives the separating element a higher-quality appearance. For example, it can be provided to produce the appearance of a metallic separating element by means of the decorative printing.

The important difference between the exemplary embodiment described according to FIGS. 1 to 4 and the second exemplary embodiment according to FIGS. 5 and 8 consists in the construction of the control panel 3′ and the barrier 11. In this case, the barrier 11 is likewise formed by a step-shaped elevation 12 formed from a glass ceramic material, which projects significantly above the plane of the cooking area, adjacent to which is the control panel 3′ comprising the display elements 6′ and operating elements 7′, which is inclined with respect to the horizontal cooking area 2′ and which faces the operator standing in front of the cooking surface 10, i.e., with its control panel 3′. In this exemplary embodiment the opposing lateral surface edges of the cooking surface 10 are also provided with boundary strips 8′ adjacent to the ends of the elongated barrier 11 which, in contrast to the embodiment according to FIGS. 1 to 4, are formed as correspondingly slightly inclined in the area of the control panel 3′.

1-9. (canceled)

10. A cooking surface on a glass ceramic or other comparable material, comprising:
a cooking area formed on the cooking surface;
said cooking area having a plurality of heatable hot plates formed thereon;
said cooking surface also including a control panel thereon, said control panel including at least one of a plurality of operating and display elements;
said cooking area and said control panel delimited from one another by a barrier which extends substantially over the whole dimension of said cooking surface in a first direction between said cooking area and said control panel;
said barrier, said cooking area and said control panel are formed from substantially the same material; and
said barrier interrupts the surfaces of said cooking area and said control panel.

11. The cooking surface according to claim 10, including said barrier, said cooking area and said control panel are formed in one piece.

12. The cooking surface according to claim 10, including said barrier is formed as an elongated, bead-shaped elevation.

13. The cooking surface according to claim 12, including said barrier further including printing on said elevation.

14. The cooking surface according to claim 10, including said barrier is formed as an elongated, roof-shaped elevation.

15. The cooking surface according to claim 10, including said cooking area surface is in a substantially horizontal plane and said control panel surface is inclined to said horizontal cooking area surface.

16. The cooking surface according to claim 10, including said cooking area and said control panel surfaces are located substantially in a common plane.

17. The cooking surface according to claim 16, including said at least one further layer associated with said colored layer is an adhesive promoting layer for said colored layer provided between said colored layer and said surface of said borosilicate glass pane.

18. The cooking surface according to claim 10, including said cooking surface is substantially rectangular and said cooking surface, including both said cooking area and said control panel includes on at least two opposing surface edges boundary strips adjacent to the ends of said elongated barrier, said boundary strips substantially orthogonal to said barrier first direction.
